(19) United States
(12) Patent Application Publication
(10) Pub. No.: US 2005/0006198 A1
(43) Pub. Date: Jan. 13, 2005

(54) Money validating machine

(75) Inventors: Kazuei Yoshioka, Tokyo (JP); Jun Fujimoto, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Tokyo (JP)

(21) Appl. No.: 10/826,908

(22) Filed: Apr. 19, 2004

(30) Foreign Application Priority Data
Apr. 23, 2003 (JP) 2003-118202

(51) Int. Cl. G06K 7/00; G07D 7/00; G07F 7/04; G06K 9/00

(52) U.S. Cl. 194/302

(57) ABSTRACT

In a money validating machine, the reliability deterioration associated with failure is prevented while making the device higher-performed. This money validating machine has a money validation unit for validating money provided from outside; and a detachable money storage unit for storing the money that has been determined as valid by the money validation unit, wherein when the money validation unit is electrically connected to the money storage unit, the money validation unit supplies both electric power and a money information signal representing information on the money to be stored in the money storage unit to the money storage unit via two power-signal connections.

### CROSS-REFERENCE TO THE RELATED APPLICATION

This application is based upon and claims a priority from the prior Japanese Patent Application No. 2003-118202 filed on Apr. 23, 2003, the entire contents of which are incorporated herein by reference.

### BACKGROUND OF THE INVENTION

1. Field of the Invention

The present invention relates to a money validating machine to be used for a gaming machine such as a slot machine, a vending machine, and so on.

2. Description of a Related Art

Conventionally, a money validating machine having a money validation unit for validating money inserted from the money insertion slot of a gaming machine, etc. and a money storage unit for storing the money that has been determined as valid and discharged by this money validation unit has been known. In such money validating machine, the money storage unit can be detached easily from the main body of the money validating machine. Therefore, when money is stored in the money storage unit, the money storage unit can be taken out and carried with the money stored therein.

As a related technology, Japanese Patent Application Publication JP-A-8-123991 discloses a money storage unit having a lid provided at the money take-out opening of the money storage unit and automatically locked for preventing the money inside from being taken out easily during carriage. The money validating machine having such money storage unit uses a motor or solenoid as a power source for locking and unlocking the lid at the money take-out opening of the money storage unit. Further, in the case where the driving source for the function of the money storage unit is directly provided in the money storage unit, electric power is needed to be supplied to the driving source, and this electric power is supplied via connection terminals provided in the main body of the money validating machine and the money storage unit.

Furthermore, in the money validating machine, in order to confirm afterwards whether or not the money inside has been lost during carriage of the money storage unit, such money information on which kinds of and how much money is stored from the money storage unit is sometimes stored in the money storage unit. Generally, the money information stored in the money storage unit is acquired by the discrimination of money by the money validation unit on the money validating machine main body side, and stored in a volatile memory, etc. built in the money storage unit. Accordingly, the signal representing such money information is supplied from the money validation unit to the money storage unit via the connection terminals provided in the main body of the money validating machine and the money storage unit. Further, the stored money information is read out via the connection terminals provided in the money storage unit by a computer installed in the place for money collection, for example.

Thus, as the money storage unit itself is being made higher-performed by including the information memory function and the motor in response to the requests for higher functions of the money validating machine, the number of connection terminals required for performing transmission and reception of power and signals to and from the main body of the money validating machine is increasing.

On the other hand, there is a problem that the increase of the connection terminals leads to deterioration in the reliability of the entire device. That is, if any one of the terminals fails, for example, the lid of the money storage unit becomes unopenable, and the entire money validating machine becomes unusable, and further, the gaming machine or the automatic venting machine in which the money validating machine is mounted itself also becomes unusable. Such device constitutes a serial system with no redundancy in view of reliability analysis. In this case, the reliability of the entire device is generally obtained as a multiplier of the reliability with respect to individual terminals. In the case where the reliability of the individual terminals are equal, the reliability of the entire device is the reliability per one terminal to the power of the number of the terminals. Therefore, the increase in the number of terminals exerts a large effect on the reliability of the entire device.

Further, since the money storage unit is constituted by a hard and rigid material in order to make it to function as a kind of portable safe from which the money inside can not be taken out easily, the unit has considerable weight, and an operator often gives momentum or presses to it with considerable force when the money storage unit is mounted to the main body of the money validating machine. Further, in the gaming machine, etc., since the medals and cash stored in the money storage unit are collected at frequent intervals, it is not easy to maintain the life of terminal contact points of the money storage unit equally to the reliability of other electronic components. Thus, the connection terminal of the money storage unit often becomes a bottleneck in view of the reliability in the money validating machine.

### SUMMARY OF THE INVENTION

The present invention has been achieved in view of the above-described circumstances. An object of the present invention is to prevent reliability deterioration associated with failure of a money validating machine while making the money validating machine higher-performed.

In order to solve the above-described problems, a money validating machine according to one aspect of the present invention comprises: a money validation unit for validating money provided from outside; and a detachable money storage unit for storing the money that has been determined as valid by the money validation unit; wherein when the money validation unit is electrically connected to the money storage unit, the money validation unit supplies both electric power and a money information signal representing information on the money to be stored in the money storage unit to the money storage unit via two power-signal connections.

According to the present invention, the power-signal connections through which the money validation unit performs electric power supply and information signal transmission to the money storage unit are brought together into two. The money storage unit can receive the electric power and the money information signal via these two power-signal connections. That is, in the money validating machine, only two sets of lines are required for the money storage unit to receive the electric power and the transmitted information from the money validation unit. Thus, by suppressing the used number of the connection terminals having a given limit in reliability, the failure reliability deterioration of the entire money validating machine can be suppressed.

In this application, “money” means a medium for exchange of products, or a portable medium for playing games. Therefore, “money” includes not only bills or coins issued by the government, etc., but also, for example, medals available only in a specific game arcade.

Further, “two power-signal connections” means that the supply of power and signals is performed by two electric connections, and the present invention includes, for example, the case where one of them is electrically connected as a casing ground by the contact between the money storage unit casing and the money validation unit casing without using a special connection terminal, a lead wire, or the like and only the other one is connected by using a connection terminal or a lead wire.

### BRIEF DESCRIPTION OF THE DRAWINGS

FIG. 1 shows the appearance of a money validating machine according to a first embodiment of the present invention;

FIG. 2 shows the appearance of the money validating machine according to the first embodiment of the present invention in a condition in which a bill storage unit is detached;

FIG. 3 shows the appearance of the bill storage unit of the money validating machine according to the first embodiment of the present invention;

FIG. 4 shows a block diagram of control circuits provided in the money validating machine according to the first embodiment of the present invention;

FIG. 5 is a circuit diagram of a bill validation control circuit of the money validating machine according to the first embodiment of the present invention;

FIG. 6 is a circuit diagram of a bill storage control circuit of the money validating machine according to the first embodiment of the present invention;

FIG. 7 shows signal waveforms in the respective parts of the control circuits in the money validating machine according to the first embodiment of the present invention;

FIG. 8 is a flowchart showing validation side main control processing in the money validating machine according to the first embodiment of the present invention;

FIG. 9 is a flowchart showing validation side signal encoding processing in the money validating machine according to the first embodiment of the present invention;

FIG. 10 is a flowchart showing storage side signal decoding processing in the money validating machine according to the first embodiment of the present invention;

FIG. 11 is a flowchart showing storage side main control processing in the money validating machine according to the first embodiment of the present invention;

FIG. 12 shows a block diagram of control circuits provided in a money validating machine according to a second embodiment of the present invention;

FIG. 13 is a circuit diagram of a bill validation control circuit of the money validating machine according to the second embodiment of the present invention;

FIG. 14 is a circuit diagram of a bill storage control circuit of the money validating machine according to the second embodiment of the present invention;

FIG. 15 is a signal waveform chart in the respective parts of the control circuits in the money validating machine according to the second embodiment of the present invention;

FIG. 16 is a flowchart showing storage side signal encoding processing in the money validating machine according to the second embodiment of the present invention;

FIG. 17 is a flowchart showing validation side signal decoding processing in the money validating machine according to the second embodiment of the present invention;

FIG. 18 shows a bill storage unit and a collection device of a money validating machine according to a third embodiment of the present invention; and

FIG. 19 is a block diagram of the money validating machine according to the third embodiment of the present invention.

### DESCRIPTION OF THE PREFERRED EMBODIMENTS

Hereinafter, embodiments of the present invention will be described in detail by referring to the drawings. In these embodiments, the present invention is applied to a bill handling device.

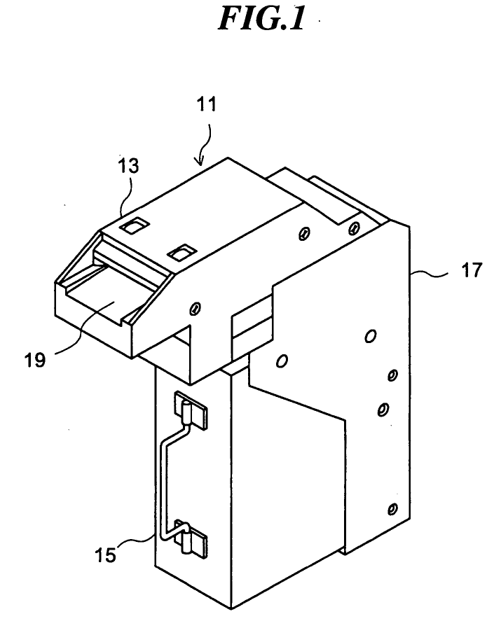

FIG. 1 shows the appearance of a bill handling device 11 as a money validating machine according to the first embodiment of the present invention. The bill handling device 11 includes a bill validation unit 13 for determining the validity of bills, a bill storage unit 15 for stacking and storing a large number of bills, and a main body unit 17 for accommodating the bill storage unit 15. The bill storage unit 15 can be attached to or detached from the main body unit 17. The bill validation unit 13 has a bill reception opening 19 to be used when inserting bills from outside of a gaming machine, an automatic vending machine, etc. in which the bill handling device 11 is installed.

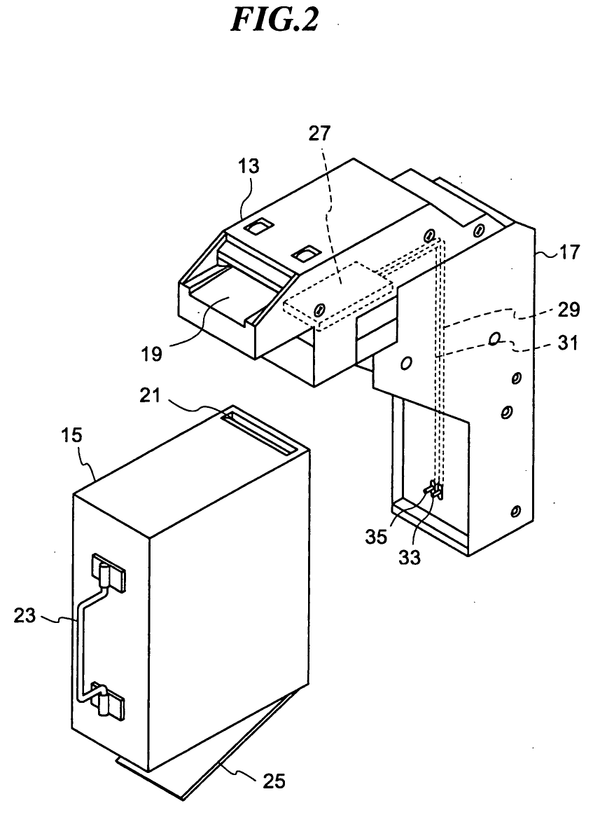

FIG. 2 shows the appearance of the bill handling device 11 in a condition in which the bill storage unit 15 is detached from the bill handling device 11. In the bill storage unit 15, a handle 23 for holding the bill storage unit 15 when carrying is provided. This handle 23 is also used for holding the bill storage unit 15 when attaching the bill storage unit 15 to the main body unit 17 and when detaching the bill storage unit 15 from the main body unit 17. Further, the bill storage unit 15 has a bill storage opening 21 to be used when transferring a bill to the inside of the bill storage unit 15 after the inserted bill is judged as being valid by the bill validation unit 13. Furthermore, the bill storage unit 15 has a lid 25 to be used when taking out bills stored within the bill storage unit 15.

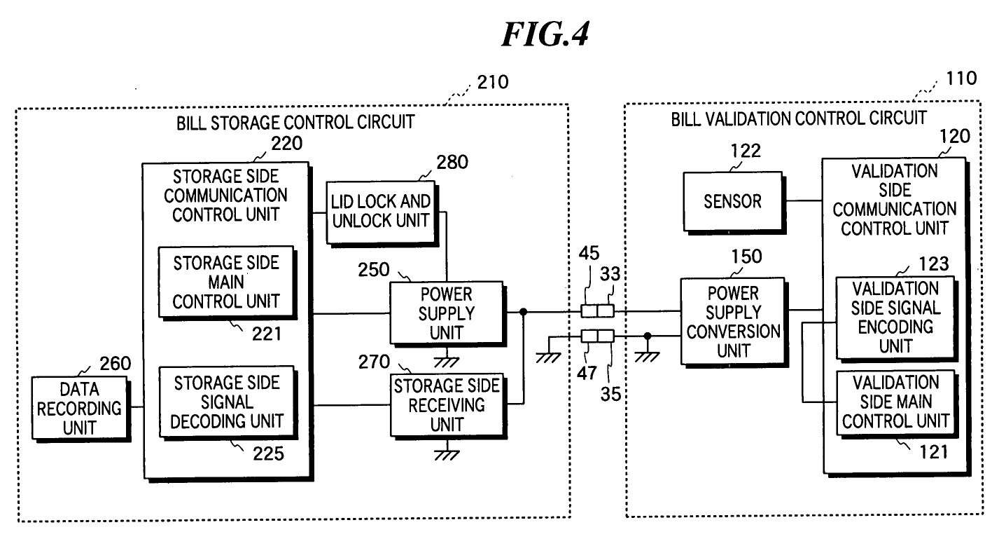

The bill validation unit 13 has a bill validation control circuit board 27 built in. In the bill validation control circuit board 27, a bill validation control circuit 110 (see FIG. 4) for controlling the drive of a motor for carrying bills, judging validity of the bills as being real or false by detecting signals from a sensor for bill discrimination, and further, transmitting signals to the bill storage unit 15 is mounted.

The main body unit 17 includes connection terminals 33 and 35. The bill validation control circuit board 27 and the connection terminals 33, 35 are connected to each other by two power-signal lines 29 and 31. Each of the connection terminals 33 and 35 is constituted by a rod-like projection made of a conductive material, and movable while being pressed into the interior side of the main body unit 17, while each of them is energized toward the side where the projection projects by a built-in elastic member.

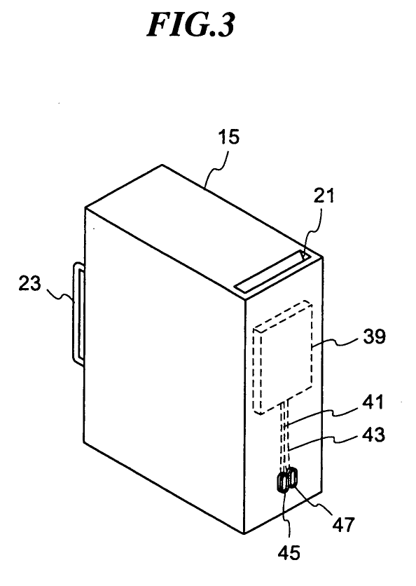

FIG. 3 shows the bill storage unit 15 seen from the opposite side of the side where the handle 23 is provided. The bill storage unit 15 has a bill storage control circuit board 39 built in. In the bill storage control circuit board 39, there is mounted a bill storage control circuit 210 (see FIG. 4) for monitoring the condition of the bill storage unit 15, and storing money information on kinds and quantity of the stored bills.

Further, the bill storage unit 15 includes connection terminals 45 and 47, and the bill storage control circuit board 39 and the connection terminals 45, 47 are connected to each other by two power-signal lines 41 and 43. Each of the connection terminals 45 and 47 is an oval flat plate made of a conductive material. In the case where the bill storage unit 15 is attached to the main body unit 17, the flat plate connection terminals 45 and 47 are pressed against the projecting connection terminals 33 and 35 provided to the main body unit 17, respectively, thereby electrically connected. Since the flat plate connection terminals 45 and 47 are pressed against the projecting connection terminals 33 and 35 (see FIG. 2) energized by the elastic members, good contact is maintained.

As described above, the connection terminal 33 on the side of the main body unit 17 and the connection terminal 45 on the side of the bill storage unit 15 form a first set of connectors, while the connection terminal 35 on the side of the main body unit 17 and the connection terminal 47 on the side of the bill storage unit 15 form a second set of connectors. By the connection of these two sets of connection terminals, the bill validation control circuit board 27 on the side of the bill validation unit 13 and the bill storage control circuit board 39 on the side of the bill storage unit 15 are connected via the power-signal lines 29 and 41 and the power-signal lines 31 and 43.

Since the connection terminal has a constant failure rate, by suppressing the increase of the number of the connection terminals by using one connection terminal for both power and signal transmission as described above, the reliability of the entire bill handling device 11 can be raised.

Next, the operation of the bill handling device 11 will be described. The bill handling device 11 is normally installed within the cabinet of a gaming machine such as a slot machine, a change machine, an automatic vending machine and so on, and a part of the bill reception opening 19 is exposed outside the cabinet of the gaming machine, etc. When a bill is inserted through the bill reception opening 19, the bill storage unit 15 drives the built-in motor under the control of the bill validation control circuit 110 mounted on the bill validation control circuit board 27, and draws the bill inside thereof. At that time, a signal from a sensor 122 (see FIG. 4) is detected by the bill validation control circuit 110 and compared with detection data on the true bills that has been stored in advance, and the validity of the bill is judged as being real or false.

As a result of the above judgment, in the case where the bill is judged as being invalid, the bill validation unit 13 sends back the inserted bill toward the bill reception opening 19. On the other hand, in the case where the bill is judged as being valid, the validation unit 13 transfers the inserted bill from the bill storage opening 21 to the bill storage unit 15. The bill storage unit 15 stores the transferred bills inside thereof by stacking them.

When the validation unit 13 transfers the bill that has been judged as being valid from the bill storage opening 21 to the bill storage unit 15, the information on the kind of the transferred bill is transmitted from the bill validation control circuit 110 (see FIG. 4) to the bill storage control circuit 210 of the bill storage unit 15. In the bill storage control circuit 210, kinds and quantity of the bills that have been stored in the bill storage unit 15 are stored cumulatively.

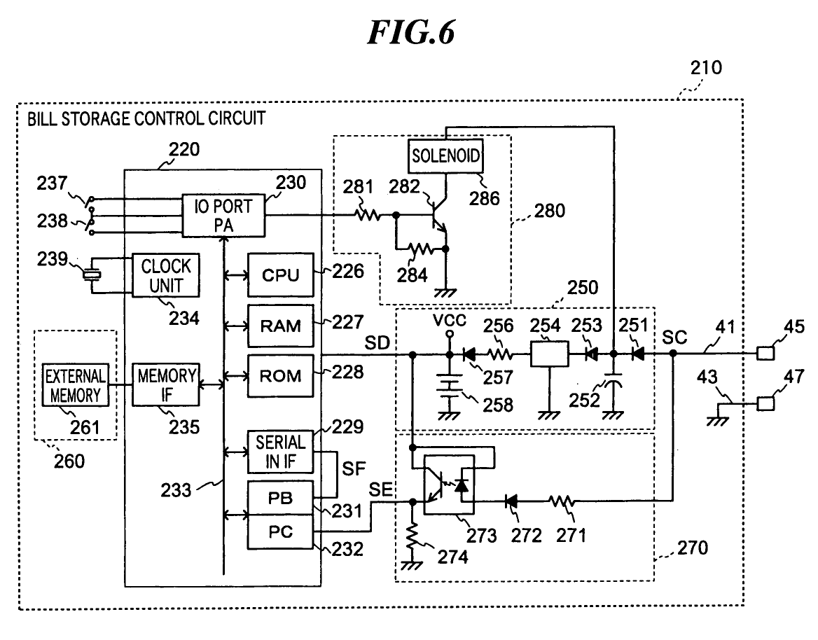

When the bills stored in the bill storage unit 15 are collected, the bill storage unit 15 is detached from the main body unit 17. The lid 25, which is opened when the bills stored within the bill storage unit 15 are taken out, is normally locked by a solenoid 286 (see FIG. 6). However, when a secret number signal is inputted via the connection terminals 45 and 47 from outside of the bill storage unit 15, the bill storage control circuit 210 within the bill storage unit 15 drives the solenoid 286 to unlock the lid 25.

Further, when the bills stored within the bill storage unit 15 are collected, the money information on the kinds and quantity of the bills stored in the bill storage unit 15, which information has been stored in the bill storage control circuit 210, can be read out via the connection terminals 45 and 47 from outside of the bill storage unit 15. Thereby, whether or not the bill that is determined as being valid by the bill validation unit 13 and stored within the bill storage unit 15 is actually stored within the bill storage unit 15 can be confirmed. Further, in the worst case where bills are lost during carriage of the bill storage unit 15, the kind and quantity of the lost bills can be known.

Next, the configurations of the control circuits for controlling the bill handling device 11 will be described by referring to a block diagram of FIG. 4.

In the bill validation unit, the bill validation control circuit 110 for performing control of the communication with the bill storage unit is mounted. The bill validation control circuit 110 includes a validation side communication control unit 120 for performing generation of communication data, etc., a power supply conversion unit 150 connected to the validation side communication control unit 120, and a sensor 122 such as a photo-sensor and a magnetic sensor for detecting the condition of the bill provided through the bill reception opening.

The validation side communication control unit 120 is constituted by a microcomputer unit (MCU, so-called “microcomputer”) in which a CPU (central processing unit), ROM, RAM, etc. are integrated into one IC, and software (program). The CPU performs processing in cooperation with the RAM, an IO port, and a serial interface and in accordance with the program stored in the built-in ROM. Thereby, the validation side communication control unit 120 generates money information such as kinds and numbers of bills to be transmitted to the bill storage control circuit 210.

Further, the validation side communication control unit 120 has a validation side main control unit 121 and a validation side signal encoding unit 123 as a functional block realized by the MCU and the program. The validation side main control unit 121 performs serial format conversion for converting the money information into the format that can be serially transmitted. Further, the validation side signal encoding unit 123 converts the serial format converted money information signal into a pulse signal of RZ (return to zero) code format.

The power supply conversion unit 150 is constituted by a current-driven operational amplifier or a voltage level shifter, and performs supply/stoppage of the output current in accordance with the pulse signal generated by the validation side signal encoding unit 123.

One of the outputs of the power supply conversion unit 150 is connected to the connection terminal 33, and the other of the outputs is connected to the connection terminal 35 as a ground level signal.

In the bill storage unit of the bill handling device, there is disposed the bill storage control circuit 210 for receiving data from the bill validation unit and recording the data. The bill storage control circuit 210 has a power supply unit 250, a data recording unit 260, a storage side receiving unit 270, and a lid lock/unlock unit 280.

The power supply unit 250 is constituted by a diode, a three-terminal regulator, etc. The power supply unit 250 extracts only a power component from the combined voltage of the power component and a signal component supplied from the connection terminal 45 via the power-signal line, and supplies a stable power supply voltage to a storage side communication control unit 220, etc. within the bill storage control circuit 210.

The storage side receiving unit 270 is constituted by a diode, a photo-coupler, etc. The storage side receiving unit 270 extracts only a signal component from the combined voltage of a power component and the signal component supplied from the connection terminal 45 via the power-signal line. Specifically, the storage side receiving unit 270 outputs a high level when the combined voltage is equal to or more than a predetermined value, and a low level when the combined voltage is equal to or less than the predetermined value.

The storage side communication control unit 220 is constituted by a microcomputer unit (MCU, so-called “microcomputer”) in which a CPU (central processing unit), ROM, RAM, etc. are integrated into one IC, and software (program). The storage side communication control unit 220 receives power supply from the power supply unit 250, and is connected to the data recording unit 260, the storage side receiving unit 270, and the lid lock/unlock unit 280.

The built-in CPU performs processing in cooperation with the RAM, an IO port, and a serial interface according to the program stored in the built-in ROM. Thereby, the storage side communication control unit 220 converts a pulse signal of RZ code format, which will be described later, outputted from the storage side receiving unit 270 into a serial format money information signal of NRZ (non return to zero) code format.

Here, “NRZ (non return to zero)” is one of code transmission systems for data communication, and means a non return to zero code format in which the signal pulse has a high level when the data is “1” and has a low level when the data is “0”, and the signal level does not change during one unit time slot period. On the contrary, “RZ (return to zero)” means a return to zero code format in which the level of the signal pulse returns to the reference level during the one unit time slot period.

Further, the storage side communication control unit 220 has a storage side main control unit 221 and a storage side signal decoding unit 225 as a functional block realized by the MCU and the program. The storage side main control unit 221 receives the serial format money information signal and controls the data recording unit 260 to store it.

The data recording unit 260 is constituted by a non-volatile memory such as an EEPROM or a flash memory, and connected to the storage side communication control unit 220. The data recording unit 260 stores the data outputted from the storage side main control unit 221 of the storage side communication control unit 220, and further, outputs the data read out by the storage side main control unit 221.

As described above, since the bill validation control circuit 110 includes the power supply conversion unit 150 for performing supply/stoppage of the output current to be supplied via the power-signal lines in accordance with the pulse signal, and the bill storage control circuit 210 includes the power supply unit 250 for extracting only the power component from the combined component supplied via the power-signal line to perform a stable power voltage supply and the storage side receiving unit 270 for extracting only the signal component from the combined component supplied via the power-signal line, only two power-signal lines including the ground reference potential line are required. Therefore, only the two sets of connection terminals 33, 45, 35, and 47 are required, and the number of the connection terminals having a predetermined failure rate is prevented from increasing, and thereby, the reliability of the entire bill handling device 11 can be raised.

Further, to the bill storage control circuit 210, the lid lock/unlock unit 280 constituted by a solenoid and a control circuit for controlling its drive is connected. The lid lock/unlock unit 280 is connected to the storage side communication control unit 220, and drives the locking mechanism for locking and unlocking the lid 25 of the bill storage unit 15 in accordance with the control signal from the storage side communication control unit 220. Thereby, even in the condition in which the bill storage unit 15 is detached from the main body unit 17 of the bill handling device 11, locking control is performed so as not to allow the lid 25 to open accidentally.

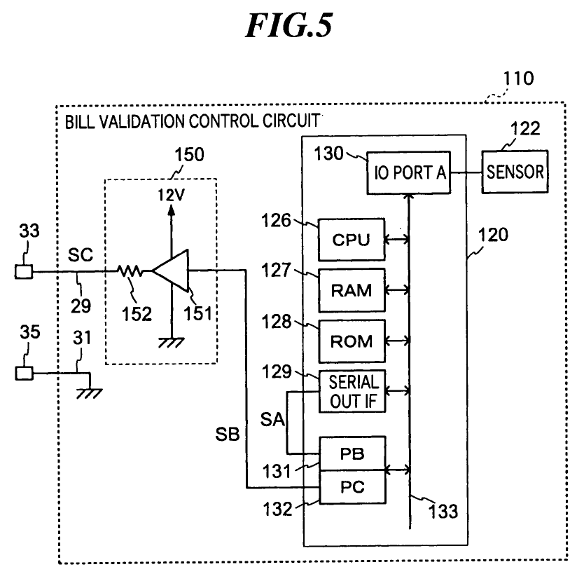

Next, more detailed configuration of the control circuits for controlling the bill handling device will be described by referring to circuit diagrams of FIGS. 5 and 6.

Referring to FIG. 5, the validation side communication control unit 120 is constituted by a microcomputer unit (MCU, so-called “microcomputer”) and software (program) . In the MCU, a CPU (central processing unit) 126 for performing readout, writing, and operation on the data according to the program, a ROM 128 for storing the program, a RAM 127 for storing the operation data, a serial output interface (hereinafter, also referred to as serial OUT IF) 129 for converting the data into a specific serial format and outputting it to the terminals, an IO port A 130, an IO port B 131, and an IO port C 132 (hereinafter, also referred to as PA, PB, and PC, respectively) are integrated into one IC in a state connected by a bus 133.

The CPU 126 performs processing in cooperation with the RAM 127 and the serial output interface 129 in accordance with the program stored in the built-in ROM 128, and thereby, the validation side communication control unit 120 realizes the validation side main control unit 121 (FIG. 4) for generating money information such as kinds and numbers of bills to be transmitted to the bill storage control circuit 210, coding the money information and performing serial format conversion that enables the money information to be serially transmitted.

The serial output interface (serial OUT IF) 129 is constituted by a shift register and a clock frequency divider, and outputs the serial format signal of the pace synchronous system with the same timing as defined in the EIA/TIA-232 (RS-232) standard.

For example, in the case where the validation side main control unit 121 transmits the data of “86” in hex, the CPU 126 writes the data of “86” in the serial output interface 129. Then, the serial output interface 129 outputs the values of “0100001101” sequentially with fixed intervals from the MSB, which values are made by adding a start bit of “0” to the front end and a stop bit of “1” to the back end of “10000110” in which the data is replaced into binary numbers.

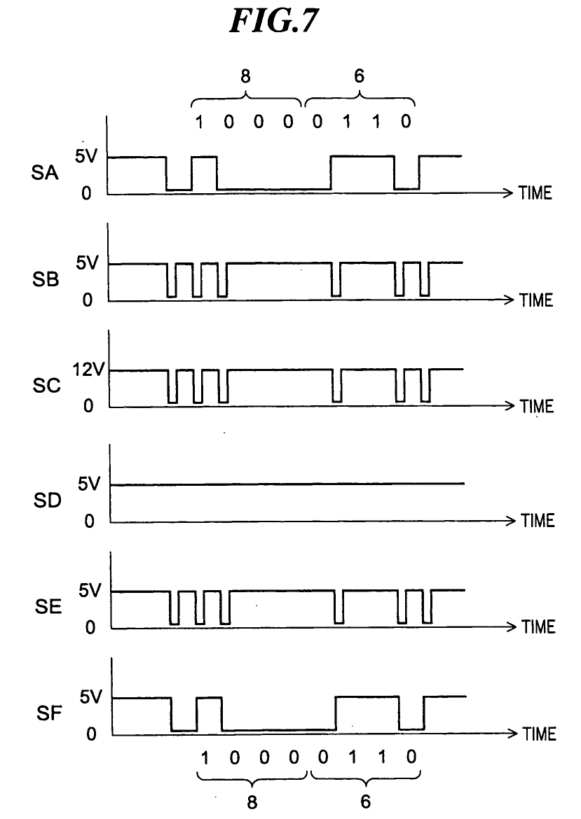

Accordingly, the waveform of the output signal SA of the serial output interface 129 becomes “LHLLLLHHLH” as shown in FIG. 7. Here, “H (high level)” is a voltage level of 5V corresponding to the data “1”, and “L (low level)” is a voltage level of 0V corresponding to the data “0”. As the bit rate timing of the signal output, with 300 bit/sec to 9600 bit/sec, data transmission with less bit error can be performed by a simple circuit configuration. Furthermore, in the range from 600 bit/sec to 2400 bit/sec, the bit error becomes less and suitable data transmission speed can be obtained.

The output signal SA of the serial output interface 129 is inputted to the IO port B 131. Here, the CPU 126 performs processing in coordination with the RAM 127, the IO port B 131, and the IO port C 132 in accordance with the program stored in the built-in ROM, and thereby, the validation side communication control unit 120 realizes the validation side signal encoding unit 123 (FIG. 4) for encoding the code format into RZ code format.

The validation side signal encoding unit 123 outputs a low level signal to the IO port C 132 for a certain short duration only when the level of the signal inputted to the IO port B 131 changes, and then, outputs a high level signal to the IO port C 132.

Therefore, for example, in the case where an input signal of the waveform of the signal SA shown FIG. 7 is inputted, regarding the waveform of the output signal SB to the IO port C 132, a low level pulse for a short duration is outputted only at the point of change of the input signal, and at the high level for other durations.

The power supply conversion unit 150 includes a level shifter 151 connected to a power supply of 12V and capable of outputting current, and a resistor 152 connected in series with its output. The IO port C 132 of the validation side communication control unit 120 is connected to the input of the level shifter 151. The resistor 152 has a value of about 100 Ω, and provides a suitable impedance for the power supply to the power-signal lines.

By such configuration, for example, the waveform of the output signal SC of the power supply conversion unit 150 relative to the case where the signal of the waveform shown by SB in FIG. 7 is inputted is similar to that of the signal SB but the voltage of the high level becomes about 12V.

The output of the power supply conversion unit 150 is guided to the bill storage control circuit 210 via the power-signal line 29, the connection terminal 33, the connection terminal 45 (FIG. 6), and the power-signal line 41. Also, the ground level line is connected to the bill storage control circuit 210 via the power-signal line 31, the connection terminal 35, the connection terminal 47 (FIG. 6), and the power-signal line 43.

Referring to FIG. 6, the power-signal line 41 is connected to the power supply unit 250 and the storage side receiving unit 270.

In the power supply unit 250, the power-signal line 41 is connected to the anode of a diode 251 for current backflow prevention, and the cathode of the diode 251 is connected to the ground via a smoothing capacitor 252. Further, the cathode of the diode 251 is connected to the input of a three-terminal regulator 254 via a diode 253, and the output of the three-terminal regulator 254 becomes, via a resistor 256 and a diode 257, an output of the power supply unit 250 and is connected to the positive terminal of an auxiliary power supply battery 258.

When the power supply voltage supplied from the bill validation control circuit 110 to the power supply unit 250 is the high level, i.e., about 12V, a current flows from the anode side to the cathode side of the diode 251 to charge the capacitor 252 of the power supply unit 250. On the other hand, when the power supply voltage is the low level, i.e., about 0V, the charge charged in the capacitor 252 never flows via the diode 251. Accordingly, even when the power supply voltage supplied to the power supply unit 250 is the low level for a short duration, the voltage of the capacitor 252 never changes drastically. This power supply voltage is converted into a constant voltage of 5V, for example, by the three-terminal regulator 254 and then outputted. That is, as shown by the signal SC in FIG. 7, even in the case where the input voltage of the power supply unit 250 varies between the high level and the low level for signal transmission, the output voltage SD is kept at a constant value, and stable power is supplied.

Thus, only the power component can be taken from the power component and signal component supplied via the power-signal line 41.

In the storage side receiving unit 270, the power-signal line 41 is connected to the anode of an LED (light emitting diode) included in a photo-coupler 273 via a resistor 271 and a diode 272. The LED generates light inside the photo-coupler 273 in accordance with the current flowing therein. Further, a phototransistor included in the photo-coupler 273 accepts the generated light to flow an electric current corresponding to the accepted light. The emitter of the phototransistor is connected to the ground via a resistor 274 as an impedance element, which converts the electric current into an output voltage of the storage side receiving unit 270. The cathode of the LED and the collector of the phototransistor included in the photo-coupler 273 are connected to the output of the power supply unit 250.

The waveform of the output signal SE of the storage side receiving unit 270 is similar to that of the input signal SC, however, the high level thereof becomes substantially the same as the level of the output of the power supply unit 250 via the photo-coupler 273. Thereby, the voltage of the signal is converted into the level that can be inputted by the storage side communication control unit 220. Further, when confirming whether or not the power is supplied from the bill validation control circuit, the high voltage of the power-signal line 41 is not directly monitored, but the signal of the voltage level that can be inputted by the storage side communication control unit 220 via the photo-coupler 273 may be monitored instead.

The storage side communication control unit 220 is constituted by a microcomputer unit (MCU, so-called “microcomputer”) and software (program). In the MCU, a CPU (central processing unit) 226 for performing readout, writing, and operation on the data in accordance with the program, a ROM 228 for storing the program, a RAM 227 for storing the operation data, a serial input interface (hereinafter, also referred to as serial IN IF) 229 for converting a specific serial format data inputted from the terminal, and an IO port A 230, an IO port B 231, and an IO port C 232 (hereinafter, also written down as PA, PB, and PC, respectively) are integrated into one IC in a state connected by a bus 233. To the storage side communication control unit 220, sensors 237, 238 formed by switches, etc. for detecting that the bill storage unit 15 is detached from the main body unit 17 and the lid 25 is open are also connected.

The output of the storage side receiving unit 270 is inputted to the IO port C 232. Here, the CPU 226 performs processing in cooperation with the RAM 227, the IO port B 231 and the IO port C 232 in accordance with the program stored in the built-in ROM 128, and thereby, the storage side communication control unit 220 realizes the storage side signal decoding unit 225 (FIG. 4) for converting the code format of the input signal from RZ code format into NRZ code format.

The storage side signal decoding unit 225 inverses the output voltage level of the IO port B 231 when the level of the signal inputted to the IO port C 232 becomes the low level.

Therefore, for example, in the case where an input signal of the waveform of the signal SE shown in FIG. 7 is inputted, the waveform of the output signal SF to the IO port B 231 is inversed only when there is a low level pulse in the input signal. As a result, the waveform of the output signal SF becomes the same as the waveform of the signal SA. Further, in the operation of the storage side signal decoding unit 225, whether or not the power is supplied from the bill validation control circuit can be monitored.

The CPU 226 performs processing in coordination with the RAM 227 and the serial input interface 229 in accordance with the program stored in the built-in ROM, and thereby, the storage side communication control unit 220 realizes the storage side main control unit 221 (FIG. 4) for decoding the signal transmitted in the serial format into data such as money information.

The serial input interface 229 is constituted by a shift register, and decodes the serial format signal of the pace synchronous system with the same timing as defined in the EIA/TIA-232 (RS-232) standard.

For example, in the case where the signal SF outputted from the storage side signal decoding unit 225 is “LHLLLLHHLH” as shown in FIG. 7, by capturing the bits sequentially with fixed intervals from the MSB except the front end stop bit L and the back end stop bit H, the data of “86” in hex is obtained.

Referring to FIGS. 4 to 6, as described above, the data “86” transmitted by the validation side main control unit 121 is received by the storage side main control unit 221 via the connection terminals 33, 45, and the power-signal lines 29, 41. Further, the obtained data is written in the memory interface 235. The memory IF 235 performs communication with an external memory 261 constituting the data recording unit 260, and allows the external memory 261 to store the written data. In the case where the obtained data is an instruction on lock or unlock of the lid 25, the storage side main control unit 221 controls a transistor 282 of the lid lock/unlock unit 280 connected to the IO port A 230 by writing data into the IO port 230A, and drives the solenoid 286 for locking and unlocking the lid 25.

As described above, the data is converted into the serial format, and thereby, can be transmitted by two lines. Furthermore, the serial format converted signal is converted into RZ code format, and, in response thereto, by performing transmission of the signal in which the power level outputted from the power supply conversion unit 150 becomes the low level only for a short duration relative to the time constant of the smoothing capacitor 252 of the power supply unit 250, the power supply and the signal transmission can be simultaneously served while keeping the output waveform of the power supply unit 250 smooth. Here, in the case where the low level duration of the voltage pulse when the signal is transmitted to the power-signal line is between 20 psec and 10 nsec, the smoothness of the output waveform of the power supply unit 250 can be kept good. Furthermore, the smoothness becomes better between 50 psec and 2 nsec.

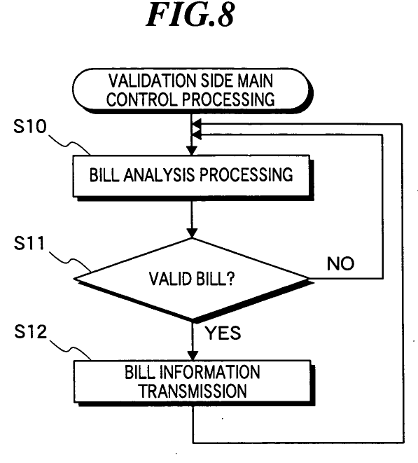

Next, the validation side main control processing performed by the CPU 126 of the validation side communication control unit 120 based on the program stored in the ROM 128 will be described by referring to a flowchart of FIG. 8.

First, the CPU 126 performs analysis processing of the inserted bill at step S10. The processing of the bill discrimination is performed by reading the data of the sensor 122 and comparing it with the reference value stored in the ROM 128, for example.

Then, the CPU 126 performs judgment whether or not the inserted bill is valid from the result of the above-mentioned analysis processing (step S11). In the case where the inserted bill is judged as being invalid, the CPU 126 shifts the processing to step S10. On the other hand, in the case where the inserted bill is judged as being valid, the CPU 126 shifts the processing to step S12.

At step S12, the CPU 126 transfers the bill to the bill storage unit 15 and transmits money information. Specifically, the CPU 126 writes the information on the bill kind from the analysis result in the serial output interface 129. Then, the CPU 126 shifts the processing to step S10.

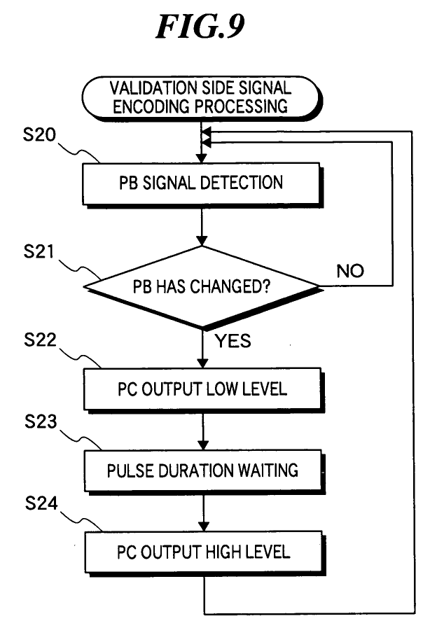

Next, the validation side signal encoding processing performed by the CPU 126 of the validation side communication control unit 120 based on the program stored in the ROM 128 will be described by referring to a flowchart of FIG. 9.

First, the CPU 126 detects the input signal of the IO port B 131 at step S20. Specifically, the CPU 126 reads out the data of the IO port B 131.

Then, the CPU 126 discriminates whether or not the input signal level of the IO port B 131 has changed from the previous detection result at step S21.

In the case where the input signal level of the IO port B 131 is judged as being unchanged from the previous detection result, the CPU 126 shifts the processing to step S20. On the other hand, in the case where the input signal level of the IO port B 131 is judged as being changed from the previous detection result, the CPU 126 shifts the processing to step S22.

At step 22, the CPU 126 makes the output of the IO port C 132 into the low level. Subsequently, the CPU 126 waits the processing for a fixed pulse duration (step S23). Further, the CPU 126 makes the output of the IO port C 132 into the high level (step S24). Then, the CPU 126 shifts the processing to step S20.

By such processing, the validation side communication control unit 120 outputs a low level pulse for a specific short duration only when the serial communication signal inputted to the IO port B 131 is inversed. Thus, the processing of converting the NRZ format signal into the RZ format signal is executed.

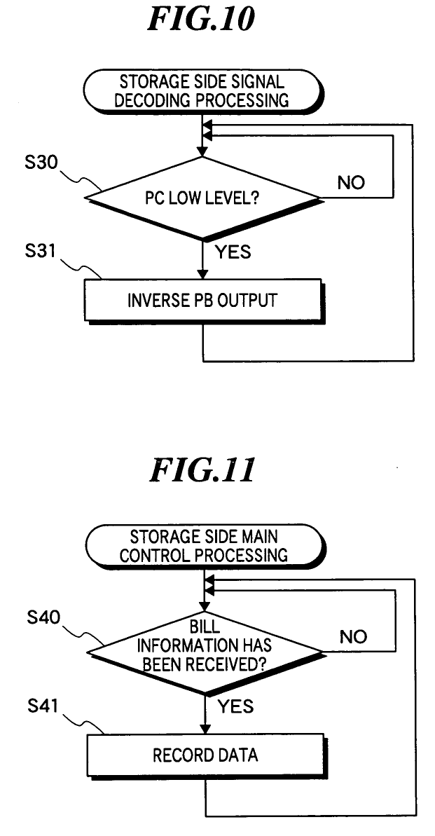

Next, the storage side signal decoding processing performed by the CPU 226 of the storage side communication control unit 220 based on the program stored in the ROM 228 will be described by referring to a flowchart of FIG. 10.

First, the CPU 226 discriminates whether or not the input signal level of the IO port C 232 is the low level at step S30. In the case where the input signal level of the IO port C 232 is judged as not being the low level at step S30, the CPU 226 repeats the processing of step S30. On the other hand, in the case where the input signal level of the IO port C 232 is judged as being the low level, the CPU 226 shifts the processing to step S31.

At step S31, the CPU 226 inverses the output level of the IO port B 231. Specifically, the CPU 226 reads out the output data of the IO port B 231 through the bus 233, the operation of inversing the logical level of the read out value, and then, writes the inversed data in the IO port B 231 again.

By such processing, the storage side communication control unit 220 can convert the pulse signal of RZ code format inputted to the IO port C 232 into the signal of NRZ code format.

Next, the storage side main control processing performed by the CPU 226 of the storage side communication control unit 220 based on the program stored in the ROM 228 will be described by referring to a flowchart of FIG. 11.

First, the CPU 226 discriminates whether or not the money information is received at step 40. Specifically, the CPU 226 reads out the value of the serial input interface 229, and compares it with a series of values representing the preset money information. The CPU 226 repeats the processing of step S40 in the case where the money information is judged as not being received. On the other hand, in the case where the money information is judged as being received, the CPU 226 shifts the processing to step S41.

At step S41, the CPU 226 records the received money information. Specifically, the CPU 226 writes the received money information in the memory interface 235. Thus, the information on the bill to be stored in the bill storage unit 15 is stored in the bill storage control circuit 210.

Next, the second embodiment of the present invention will be described.

In a bill handling device as a money validating machine according to the second embodiment of the present invention, in addition to the data transmission from the bill validation unit 13 to the bill storage unit 15 shown in FIG. 1, the signal transmission of the data from the bill storage unit 15 to the bill validation unit 13 is performed.

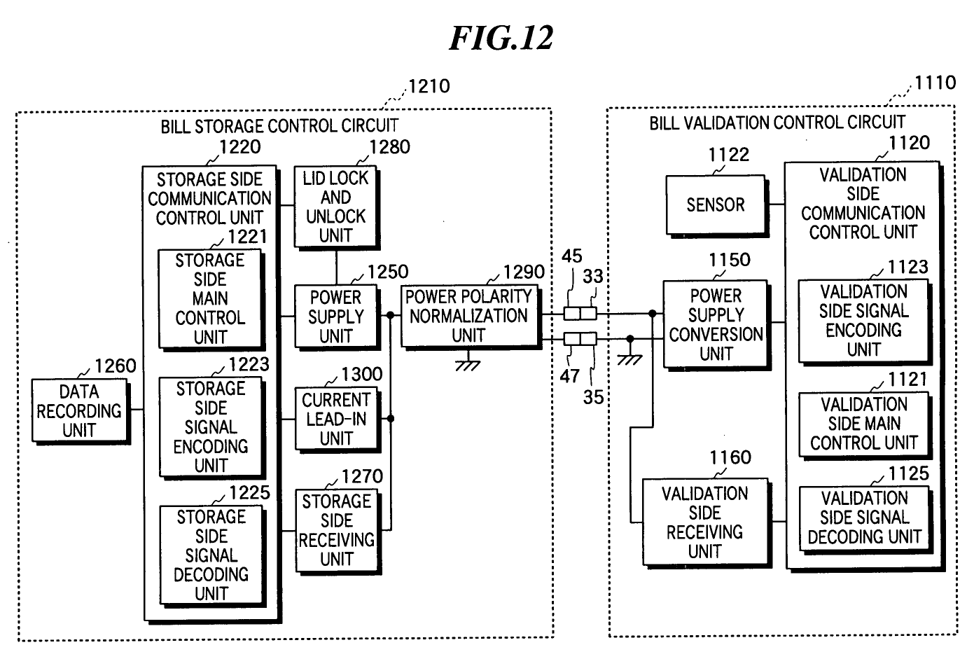

The configuration of the control circuits for controlling the bill handling device in the second embodiment will be described by referring to a block diagram of FIG. 12. The bill storage unit 15 of the bill handling device 11 includes a bill storage control circuit 1210 for receiving data from the bill validation unit 13 and recording the data. The bill storage control circuit 1210 is similar to the bill storage control circuit 210 in the above-mentioned first embodiment in the point that the circuit 1210 has a power supply unit 1250, a data recording unit 1260, a storage side receiving unit 1270, and a lid lock/unlock unit 1280.

However, the bill storage control circuit 1210 in the second embodiment is different from the bill storage control circuit 210 in the above-mentioned first embodiment in the points that a storage side communication control unit 1220 has a storage side signal encoding unit 1223, and the bill storage control circuit 1210 further includes a current lead-in unit 1300 and a power polarity normalization unit 1290.

Next, the second embodiment will be described with the focus on the power polarity normalization unit 1290, the storage side signal encoding unit 1223, and the current lead-in unit 1300 as the different points.

The power polarity normalization unit 1290 is constituted by a diode bridge. Since the power polarity normalization unit 1290 is provided in the bill storage control circuit, even if the connection terminals 33 and 35 and the connection terminals 45 and 47 are connected in wrong pairs, the polarity of the voltages inputted to the power supply unit 1250 and the storage side receiving unit 1270 become the same constantly. Thereby, especially in the case where there is a possibility that the connection terminal has the form that may be reversely connected as a cable connector, circuit components are never broken. Therefore, the reliability associated with the failure of the bill handling device 11 is improved.

Further, the storage side communication control unit 1220 is constituted by a microcomputer unit (MCU, so-called “microcomputer”) in which a CPU (central processing unit), ROM, RAM, etc. are integrated into one IC, and software (program). The CPU performs processing in cooperation with the built-in RAM, an IO port, and a serial interface, and thereby, a storage side main control unit 1221 for performing serial format conversion for enabling serial transmission of the information to be transmitted to a bill validation control circuit 1110 and the storage side signal encoding unit 1223 for converting the above-mentioned serial format converted information signal into the pulse signal of RZ code format are realized.

The current lead-in unit 1300 short-circuits the power-signal line to the ground via the diode bridge, etc. in accordance with the pulse signal generated by the storage side signal encoding unit 1223 of the storage side main control unit 1220. The power-signal line is driven by a power supply conversion unit 1150 of the bill validation control circuit 1110, and impedance is added to this drive output by a resistor 1152. Therefore, during the duration of the short-circuiting of the power-signal line via the diode bridge, etc. by the current lead-in unit 1300, the voltage of the power-signal line becomes nearly the low level.

In the bill validation unit 13 of the bill handling device 11 shown in FIG. 1, the bill validation control circuit 1110 for controlling the communication with the bill storage unit 15 is disposed. The bill validation control circuit 1110 is the same as the bill validation control circuit 110 of the above-mentioned first embodiment in the point that a validation side communication control unit 1120 for performing generation of communication data, etc., and the power supply conversion unit 1150 connected to this validation side communication control unit 1120 are included. However, the bill validation control circuit 1110 in the second embodiment is different in the point that the bill validation control circuit 1110 includes a validation side receiving unit 1160.

The validation side communication control unit 1120 is constituted by a microcomputer unit (MCU, so-called “microcomputer”) in which a CPU (central processing unit), ROM, RAM, etc. are integrated into one IC, and software (program). The CPU performs processing in cooperation with the built-in RAM, an IO port, and a serial interface in accordance with the program stored in the built-in ROM, and thereby, a validation side signal decoding unit for converting the pulse signal of RZ code format outputted from the validation side receiving unit 1160 into the information signal of the serial format, and the storage side main control unit 1221 for receiving the serial format information signal are realized.

The configurations of the control circuits in the second embodiment of the present invention will be described by referring to FIGS. 12 to 14.

To the storage side main control unit 1221 in the storage side communication control unit 1220, a function of performing serial format conversion is added, and the storage side communication control unit 1220 further includes the storage side signal encoding unit 1223 for converting the pulse signal of RZ code format. However, both of these have the same constitution and function as those of the validation side main control unit 121 and the validation side signal encoding unit 123 of the validation side communication control unit 120 in the first embodiment of the present invention.

That is, a serial output interface (serial OUT IF) 1229 is constituted by a shift register and a clock frequency divider, and performs output of the serial format signal of the pace synchronous system with the same timing as defined in the EIA/TIA-232 (RS-232) standard.

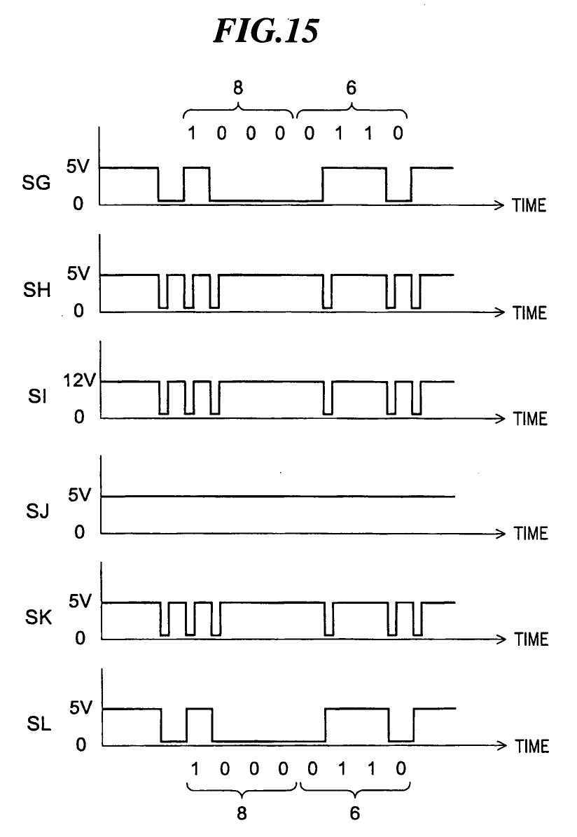

For example, in the case where the storage side main control unit 1221 transmits the data of “86” in hex, the CPU 1226 writes the data of “86” in the serial output interface 1229. Then, the serial output interface 1229 outputs the value of “0100001101” sequentially with fixed intervals from the MSB, which value is made by adding a start bit of “0” to the front end and a stop bit of “1” to the back end of “10000110” in which data is replaced into binary numbers. Accordingly, the waveform of the output signal SG of the serial output interface 1229 becomes “LHLLLLHHLH” as shown in FIG. 15.

Here, “H (high level)” is a voltage level of 5V corresponding to the data “1”, and “L (low level)” is a voltage level of 0V corresponding to the data “0”. As the bit rate timing of the signal output, with 300 bit/sec to 9600 bit/sec, data transmission with less bit error can be performed by. a simple circuit configuration. Furthermore, in the range from 600 bit/sec to 2400 bit/sec, the bit error becomes less and suitable data transmission speed can be obtained.

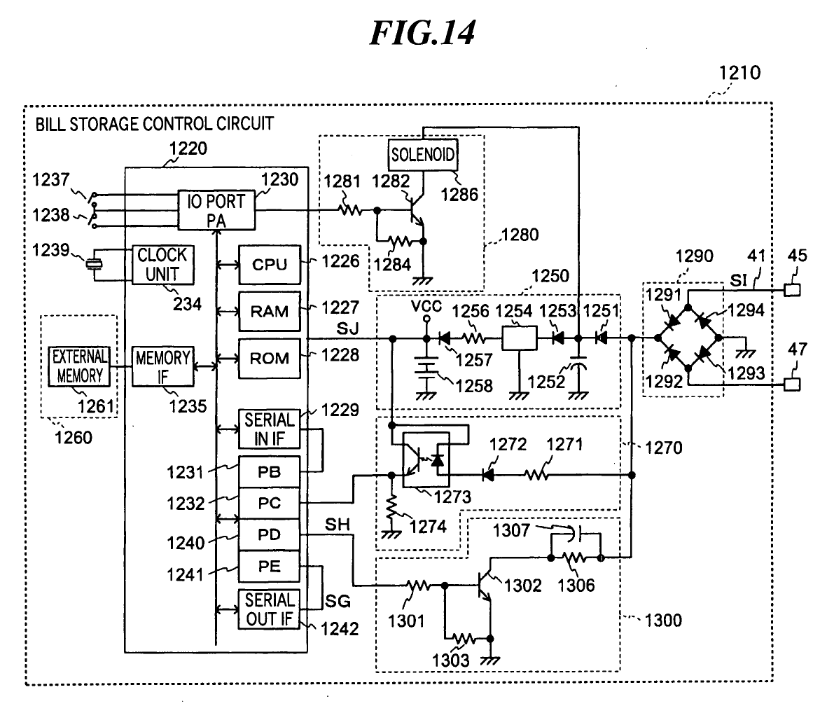

Referring to FIG. 14, the output signal SG of the serial output interface 1229 is inputted to an IO port B 1231. Here, the CPU 1226 performs processing in coordination with a RAM 1227, an IO port E 1241, and an IO port D 1240 in accordance with the program stored in a built-in ROM 1228, and thereby, the storage side communication control unit 1220 realizes the storage side signal encoding unit 1223 (FIG. 12) for encoding the code format into RZ code format.

The storage side signal encoding unit 1223 outputs the low level to the IO port D 1240 for a certain short duration only when the level of the signal inputted to the IO port E1240 changes, and then, outputs the high level to the IO port D 1240.

Therefore, for example, in the case where an input signal of the waveform of the signal SG shown in FIG. 15 is inputted, regarding the waveform of the output signal SH to the IO port D 1240, a low level pulse for a short duration is outputted only at the point of change of the input signal, and the high level is outputted for other durations.

Next, the current lead-in unit 1300 that does not exist in the bill storage control circuit 210 of the first embodiment will be described by referring to FIG. 14. The input terminal of the current lead-in unit 1300 is connected to the base of a transistor 1302 via a resistor 1301. The emitter of the transistor 1302 is connected to the ground potential, and its collector is connected to the power polarity normalization unit 1290 via a resistor 1306. Further, a speed up capacitor 1307 is connected in parallel with the resistor 1306. A resistor 1303 for saturation prevention is connected between the base and the emitter of the transistor 1302. Thus, the line on the current output side of the current lead-in unit 1300 is connected to the power-signal line 41 via a diode 1291 of the power polarity normalization unit 1290.

Here, when the signal SH from the IO port D 1240 becomes the high level, the transistor 1302 is turned ON to connect the line on the current output side to the ground level with low resistance. As a result, current is led in from the power-signal line 41 via the diode 1291 and the transistor 1302, and thereby, the voltage of the power-signal line 41 is decreased.

For example, the waveform of the signal SI of the power-signal line 41 is similar to that of SH in the case where the signal of the waveform shown by SH of FIG. 15 is inputted, however, the high level voltage becomes about 12V.

By connecting and shutting off the power supply on the bill storage unit 15 side, the same action as in the case where the power supply is encoded on the bill validation unit 13 side of the first embodiment is produced.

Even when the potential of the power-signal line 41 changes as the signal SI, the signal SJ of the power output of the power supply unit 1250 is stably supplied as well as in the first embodiment. Thus, by using the power-signal line 41 shown in FIG. 14, power is supplied from the bill validation unit 13 to the bill storage unit 15, and the signal transmission is performed from the bill storage unit 15 to the bill validation unit 13. As a result, despite that the number of the power-signal lines remains two and the number of the sets of connection connectors remains two, the signal transmission from the bill storage unit 15 to the bill validation unit 13 can be performed.

Referring to FIG. 12, in the bill validation control circuit 1110 in the second embodiment, the validation side receiving unit 1160 for extracting only the signal component from the combined voltage of the power component and the signal component in the power-signal line is added. Further, in the validation side communication control unit 1120, a validation side signal decoding unit 1125 for converting the pulse signal of RZ code format into the signal format of NRZ code format is added, and, to the storage side main control unit 1121, the processing of receiving serial format input data is added. All of these have the same constitution and function as those of the storage side receiving unit 270, the storage side signal decoding unit 225, and the storage side main control unit 221 in the first embodiment of the present invention.

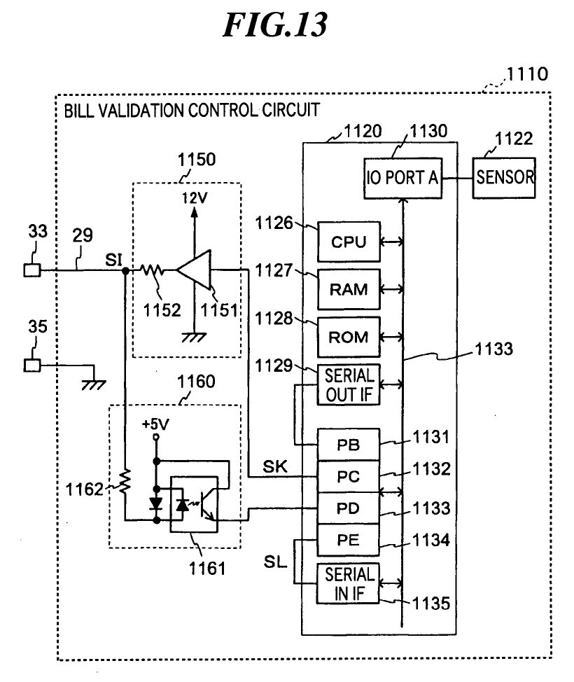

That is, as shown in FIG. 13, in the validation side receiving unit 1160, the power-signal line 29 is connected to the anode of a photo-coupler 1161 via a resistor 1162. Further, the emitter of the photo-coupler 1161 as an output end of the validation side receiving unit 1160 is connected to the port D 1133 of the validation side communication control unit 1120. The cathode and collector of the photo-coupler 1160 are connected to the 5V power supply.

The waveform of the output signal SK of the storage side receiving unit 1160 is similar to that of the input signal SI in the power-signal line 29, however, the high level thereof becomes substantially the same as the 5V power supply level via the photo-coupler 1161. Thereby, the voltage of the signal is converted into the level that can be inputted by the storage side communication control unit 1120.

The output of the validation side receiving unit 1160 is inputted to the IO port D 1133. Here, in the validation side communication control unit 1120, the CPU 1126 performs processing in cooperation with the RAM 1127, the IO port D 1133 and the IO port E 1134 in accordance with the program stored in the built-in ROM 1128, and thereby, the validation side signal decoding unit 1125 (FIG. 12) for converting the code format of the input signal from RZ code format into NRZ code format is realized.

The validation side signal decoding unit 1125 inverses the output voltage level of the IO port E 1134 when the level of the signal inputted to the IO port D 1133 becomes the low level.

Therefore, for example, in the case where an input signal of the waveform of the signal SK shown in FIG. 15 is inputted, the waveform of the output signal SL of the IO port E 1134 is inversed only when there is a low level pulse in the input signal. As a result, the waveform of the output signal SL becomes the same as the waveform of the signal SG. Then, the signal SL is inputted to the serial input interface 1135.

Thus, data transmission from the bill storage control circuit 1210 to the bill validation control circuit 1110 can be performed.

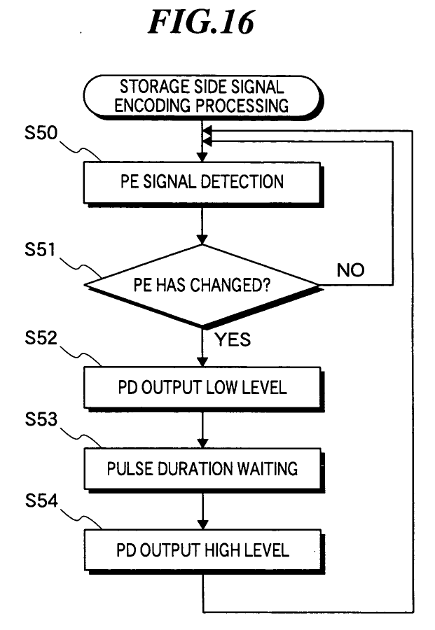

Next, the storage side main control processing performed by the CPU 1226 (FIG. 13) of the storage side communication control unit 1120 in the second embodiment based on the program stored in the ROM 1228 will be described by referring to a flowchart of FIG. 16.

First, the CPU 1226 detects the input signal of the IO port E 1241 at step S50. Specifically, the CPU 1226 reads out the data of the IO port E 1241.

Subsequently, at step S51, the CPU 1226 discriminates whether or not the input signal level of the IO port E 1241 has changed from the previous detection result. In the case where the input signal level of the IO port E 1241 is judged as being unchanged from the previous detection result, the CPU 1226 shifts the processing to step S50. On the other hand, in the case where the input signal level is judged as being changed from the previous detection result, the CPU 1226 shifts the processing to step S52.

At step 52, the CPU 1226 makes the output of the IO port D 1240 into the low level. At a step 53, the CPU 1226 waits the processing for a fixed pulse duration. At a step S54, the CPU 1226 makes the output of the IO port D 1240 into the low level. Then, the CPU 1226 shifts the processing to step S50.

By such processing, the storage side communication control unit 1220 outputs a low level pulse for a specific short duration only when the serial communication signal inputted to the IO port E 1241 is inversed. Thus, the signal of NRZ code format can be converted into the signal of RZ code format.

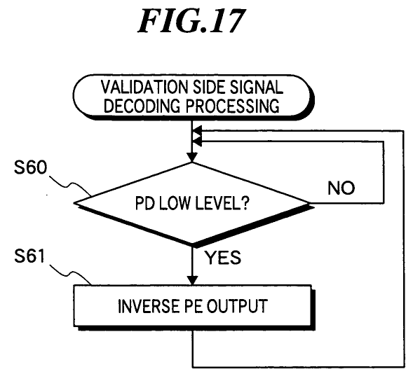

Next, the validation side signal decoding processing performed by the CPU 1126 of the validation side communication control unit 1120 based on the program stored in the ROM 1128 will be described by referring to a flowchart of FIG. 17.

First, at step S60, the CPU 1126 discriminates whether or not the input signal level of the IO port D 1133 is the low level. In the case where the input signal level of the IO port D 1133 is judged as not being the low level at step S60, the CPU 1126 shifts the processing to step S60. On the other hand, in the case where the input signal level of the IO port D 1133 is judged as being the low level, the CPU 1126 shifts the processing to step S61.

At step S61, the CPU 1126 inverses the output level of the IO port E 1134. Specifically, the CPU 1126 reads out the output data of the IO port E 1134, performs the operation of inversing the logical level of the read out value, and then, writes the inversed data into the IO port E 1134 again.

By such processing, the validation side communication control unit 1120 can convert the pulse signal of RZ code format inputted to the IO port D 1133 into the signal of NRZ code format.

In the second embodiment of the present invention, when the validation side communication control unit 1120 shown in FIG. 12 transmits the signal to the power-signal line through the power supply conversion unit 1150, this signal is also inputted to the validation side communication control unit 1120 itself through the validation side receiving unit 1160. Similarly, when the storage side communication control unit 1220 transmits the signal to the power-signal line 41 through the current lead-in unit 1300, this signal is also inputted to the storage side communication control unit 1220 itself through the storage side receiving unit 1270. Therefore, other than the data signal from the other end of the line, reception of the signal outputted by itself, so-called echo back is produced. In order to prevent the reception of the unwanted data, when the output of the signal is performed, the processing of the signal reception may be stopped.

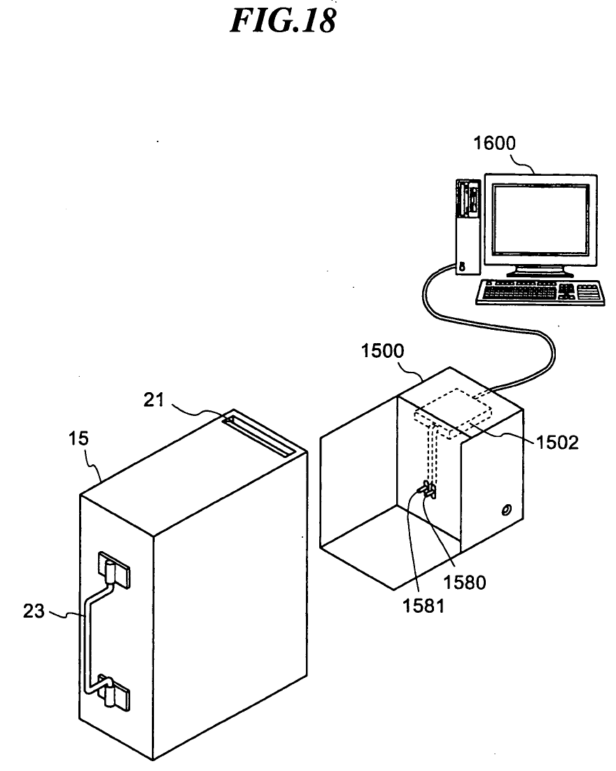

Next, the third embodiment of the present invention will be described by referring to FIG. 18.

In the third embodiment, the bill storage unit 15 in the second embodiment is detached from the bill validation unit 13 and connected to a collection device 1500.

The collection device 1500 is a relay device for transmitting the control signal for unlocking the lid 25 of the bill storage unit 15 from a terminal computer 1600 when collecting the money stored in the bill storage unit 15. Further, the collection device 1500 receives the information signal from the bill storage unit 15 and relays it to the terminal computer 1600 when the terminal computer 1600 collects the money information stored in the bill storage unit 15. Via the collection device 1500, for example, an operator can connect the terminal computer 1600 and the bill storage unit 15 so as to display the bill information stored in the bill storage unit 15 through the terminal computer 1600, and confirm the stored bill contents. Further, the operator can operate the terminal computer 1600 to transmit the control signal to the bill storage unit 15, and collect the bills by unlocking the lid 25.

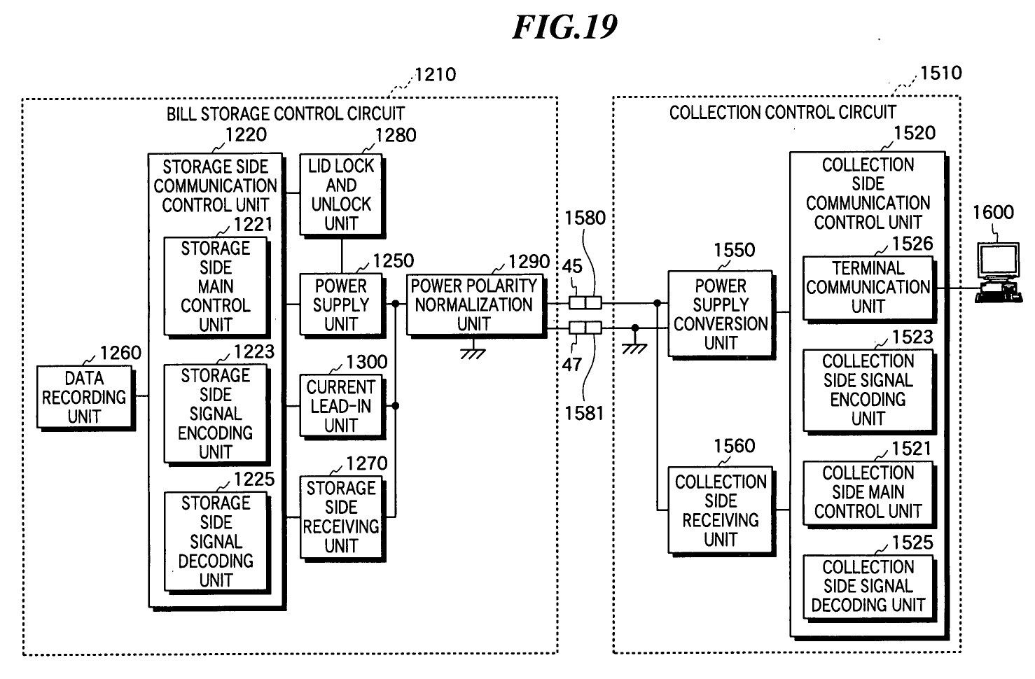

In the case where the bill storage unit 15 is mounted to the collection device 1500, the flat plate connection terminals 45 and 47 of the bill storage unit 15 are pressed against projecting connection terminals 1580 and 1581 provided in the collection device 1500, respectively, and thereby electrically connected. The connection terminals 1580 and 1581 are connected to a board 1502, on which a collection control circuit 1510 (see FIG. 19) is mounted, by using the respective power-signal lines. The board 1502 is also connected to the terminal computer 1600 outside of the collection device 1500.

The circuit configuration in which the bill storage unit 15 in the third embodiment is mounted on the collection device 1500 will be described by referring to FIG. 19. In this condition, the bill storage control circuit 1210 for controlling the bill storage unit 15 and the collection control circuit 1510 within the collection device 1500 are connected by using two power-signal lines via the connection between the connection terminals 45 and 1580 and the connection between the connection terminals 47 and 1581.

The collection control circuit 1510 includes a collection side communication control unit 1520 for performing generation of communication data, etc. To this collection side communication control unit 1520, a power supply conversion unit 1550 and a collection side receiving unit 1560 are connected.

The collection side communication control unit 1520 is constituted by a microcomputer unit (MCU, so-called “microcomputer”) in which a CPU (central processing unit), ROM, RAM, etc. are integrated into one IC, and software (program). The CPU performs processing in cooperation with the built-in RAM, an IO port, and a serial interface in accordance with the program stored in the built-in ROM, and thereby, a collection side signal decoding unit 1525 for converting the pulse signal of RZ code format outputted from the collection side receiving unit 1560 into the information signal of the serial code format, and a collection side main control unit 1521 for receiving the information signal of the serial code format are realized. The information signal is transmitted to the terminal computer 1600 through a terminal communication unit 1526.

The power supply conversion unit 1550 is constituted by a current-driven operational amplifier or a voltage level shifter, and performs supply/stoppage of the output current according to the pulse signal generated by a collection side signal encoding unit 1523 of the collection side communication control unit 1520 based on the signal transmitted from the terminal computer 1600.

The constitution and the operation of the collection side signal encoding unit 1523, the collection side signal decoding unit 1525, the power supply conversion unit 1550, and the collection side receiving unit 1560 of the collection control circuit 1510 in the third embodiment are same as the constitution and the operation of a validation side signal encoding unit 1123, the validation side signal decoding unit 1125, the power supply conversion unit 1150, and the validation side receiving unit 1160 of the bill validation control circuit 1110 in the second embodiment.

In the third embodiment, the terminal computer 1600 is operated by the operator and the control information signal for opening the lid 25 of the bill storage unit 15 is transmitted to the collection side communication control unit 1520. The transmitted control information signal is converted into the serial data format by the collection side main control unit 1521. Then, this control information signal is further converted into the pulse signal of RZ format by the collection side signal encoding unit 1523. In accordance with this pulse signal, the power supply conversion unit 1550 shuts down and connects the supply of the power to the power-signal lines.

On the other hand, in the bill storage control circuit 1210, constant power is taken from the power-signal lines to which the power supply conversion unit 1550 shuts down and connects the supply of the power. Further, the storage side receiving unit 1270 takes out the control information. The RZ format signal taken out here is converted into the NRZ format signal in a storage side signal decoding unit 1225, and transmitted to the storage side main control unit 1221. In the storage side main control unit 1221, after the validity of the control signal is verified, the lid lock/unlock unit 1280 is controlled to open the lid 25.

Further, the bill data received from the bill validation unit 13 and stored in the data recording unit 1260 when the bill storage unit 15 is connected to the bill validation unit 13 is read by the storage side main control unit 1221 and converted into the serial format. Then, the bill data is converted into RZ format in the storage side signal encoding unit 1223, and transmitted to the current lead-in unit 1300. The current lead-in unit 1300 connects the power-signal line to the ground via an element in accordance with the pulse of the signal converted into RZ format, and decreases the power voltage. In the collection side receiving unit 1560 of the collection control circuit 1510, the signal component is taken out from the waveform of the decreased power supply voltage. The signal component is converted into the NRZ format serial data by the collection side signal encoding unit 1525, and transmitted to the terminal computer 1600 through the terminal communication unit 1526 so that contents thereof are displayed.

As described above, information transmission from the collection device 1500 to the bill storage unit 15 and, reversely, from the bill storage unit 15 to the collection device 1500 is performed by using two power-signal lines. Furthermore, the two lines serves to supply the power and the signal to the bill storage unit 15 by using two power-signal lines via the two sets of connection terminals. Accordingly, only two connection terminals are required for the bill storage unit, and thereby, increase in the number of the connection terminals is suppressed, and the reliability of the entire device is raised.

In the above-mentioned embodiments, the validation side signal encoding unit, the validation side signal decoding unit, the storage side signal encoding unit, and the storage side signal decoding unit are realized by the processing of the CPU based on the computer program. However, not limited to the processing of software, the respective units may be constituted as pulse circuits and logic circuits by hardware. For example, the signal encoding unit may be constituted by a pulse generator circuit including a mono-stable multi vibrator. Further, the signal decoding unit may be constituted by a frequency divider circuit for dividing a frequency of the signal into the half.

As described above, according to the present invention, the money storage unit of the money validating machine can receive the power and money information signal via two power-signal lines. Here, only two sets of lines are required for receiving the power supply from the money validation unit and receiving transmitted information. Therefore, the reliability deterioration associated with failure of the entire money validating machine can be suppressed by suppressing the used number of the components having a given limit in reliability.

1. A money validating machine comprising:
a money validation unit for validating money provided from outside; and
a detachable money storage unit for storing the money that has been determined as valid by said money validation unit;
wherein when said money validation unit is electrically connected to said money storage unit, said money validation unit supplies both electric power and a money information signal representing information on the money to be stored in said money storage unit to said money storage unit via two power-signal connections.

2. A money validating machine according to claim 1, wherein said money validation unit has two connection terminals and said money storage unit has two connection terminals so that said money validation unit are electrically connected to said money storage unit via the two power-signal connections.

3. A money validating machine according to claim 1, wherein:
said money validation unit includes a validation side communication control unit for outputting the money information signal as a pulse signal and a power supply conversion unit for performing supply and stoppage of the electric power in accordance with the pulse signal to generate a voltage between the two power-signal connections; and
said money storage unit includes a power supply unit for supplying electric power based on the voltage between the two power-signal connections to circuits within the money storage unit, a storage side receiving unit for extracting the money information signal from the voltage between the two power-signal connections, and a storage side communication control unit for receiving the extracted money information signal.

4. A money validating machine according to claim 3, wherein said power supply unit includes:
a first diode having a first terminal connected to one of the two power-signal connections;
a capacitor connected between a second terminal of said first diode and the other of the two power-signal connections;
a second diode having a first terminal connected to the second terminal of said first diode; and
a three-terminal regulator having an input terminal connected to a second terminal of said second diode.

5. A money validating machine according to claim 3, wherein said storage side receiving unit includes:
a photo-coupler having an LED (light emitting diode) for generating light inside said photo-coupler in accordance with an electric current caused by the voltage between the two power-signal connections and a phototransistor for accepting the generated light to flow an electric current corresponding to the accepted light; and
an impedance element for converting the electric current caused by said phototransistor into a voltage corresponding to the money information signal.

6. A money validating machine according to claim 3, wherein:
said money storage unit includes a lid to be opened when the money stored within said money storage unit is collected and a lid lock/unlock unit for locking or unlocking the lid by the electric power supplied from said power supply unit; and
said storage side communication control unit controls said lid lock/unlock unit to lock or unlock the lid in accordance with a control signal received by said storage side receiving unit via the two power-signal connections.

7. A money validating machine according to claim 3, wherein:
said money storage unit further includes a current lead-in unit for transmitting a signal by leading in a current via one of the two power-signal connections in accordance with a storage unit information signal generated by said storage side communication control unit; and
said money validation unit further includes a validation side receiving unit for detecting the signal transmitted from said current lead-in unit on the basis of an electric potential of said one of the two power-signal connections.

8. A money validating machine according to claim 3, wherein the money information signal generated by said validation side communication control unit is a signal encoded to RZ (return to zero) code format.

9. A money validating machine according to claim 8, wherein said validation side communication control unit includes validation side signal encoding means for encoding the money information signal from NRZ (non return to zero) code format to the RZ code format before outputting the money information signal to said power supply conversion unit.

10. A money validating machine according to claim 8, wherein said storage side communication control unit includes storage side signal decoding means for decoding the money information signal outputted from said storage side receiving unit from the RZ code format to NRZ (non return to zero) code format.

11. A money validating machine according to claim 7, wherein said storage side communication control unit generates the storage unit information signal encoded to RZ (return to zero) code format.

12. A money validating machine according to claim 11, wherein said storage side communication control unit includes storage side signal encoding means for encoding the storage unit information signal from NRZ (non return to zero) code format to the RZ code format before outputting the storage unit information signal to said current lead-in unit.

13. A money validating machine according to claim 11, wherein said validation side communication control unit includes validation side signal decoding means for decoding the storage unit information signal inputted from said validation side receiving unit from the RZ code format to NRZ (non return to zero) code format.

14. A money validating machine according to claim 3, wherein said money storage unit includes a power polarity normalization unit for normalizing a polarity of the voltage supplied from said money validation unit via the two power-signal connections.

15. A money validating machine according to claim 14, wherein said power polarity normalization unit includes a diode bridge circuit having first and second terminals supplied with the voltage between the two power-signal connections, a third terminal for outputting a positive potential according to the supplied voltage, and a fourth terminal for outputting a negative potential according to the supplied voltage.

16. A money validating machine according to claim 2, wherein said money storage unit is able to be connected to a collection device other than said money validation unit via said two connection terminals provided in said money storage unit when said money storage unit is detached from said money validation unit.
